(19) United States
(12) Patent Application Publication
(10) Pub. No.: US 2021/0327173 A1
(43) Pub. Date: Oct. 21, 2021

(54) AUTONOMOUS VEHICLE SYSTEM AND AUTONOMOUS DRIVING METHOD FOR VEHICLE

(71) Applicant: LG ELECTRONICS INC., Seoul (JP)

(72) Inventors: Chanho PARK, Seoul (KR); Kyunghee KIM, Seoul (KR); Taehui YUN, Seoul (KR); Dongha LEE, Seoul (KR); Gaehwan CHO, Seoul (KR); Jooyoung LEE, Seoul (KR)

(73) Assignee: LG ELECTRONICS INC., Seoul (KR)

(21) Appl. No.: 17/259,507

(22) PCT Filed: May 31, 2019
(86) PCT No.: PCT/KR2019/006619

§ 371 Date: Jan. 11, 2021

(51) Int. Cl. G07C 5/08; G07C 5/00; B60W 60/00

(52) U.S. Cl. CPC G07C 5/0816; B60W 60/001; G07C 5/008

(57) ABSTRACT

The present invention relates to an autonomous vehicle system comprising: a communication device for generating a first signal on the basis of service data received from a server; a plurality of sensors for generating a second signal on the basis of sensing data which is generated; a positioning device for generating a third signal on the basis of location data of a vehicle which is generated; an autonomous driving device for recognizing a driving situation on the basis of at least one of the first signal, the second signal, and the third signal, generating an autonomous driving path on the basis of the driving situation, and generating a fourth signal for a control parameter for driving according to the autonomous driving path; and a control device for, when the fourth signal is not received, controlling at least one vehicle driving device according to the first signal.

### TECHNICAL FIELD

The present disclosure relates to an autonomous vehicle system and an autonomous driving method of a vehicle.

### BACKGROUND ART

A vehicle is an apparatus that a riding user moves in a desired direction. A representative example of such a vehicle is an automobile. An autonomous vehicle means a vehicle that can automatically travel without a driving operation of a human being. In a manual vehicle, when any one of devices provided in the manual vehicle fails, a driver may cope with such a failure at once. However, in the autonomous vehicle, when a sensor or central processing unit (CPU) of a system fails, a user may not cope with such a failure at once. An accident may occur between a failure time and a user-coping time.

### DISCLOSURE

### Technical Problem

Therefore, the present disclosure has been made in view of the above problems, and it is an object of the present disclosure to provide an autonomous vehicle system which is capable of, when any one of electronic devices of an autonomous vehicle fails, coping with such a failure.

It is another object of the present disclosure to provide an autonomous driving method which is capable of, when any one of electronic devices of an autonomous vehicle fails, coping with such a failure.

Objects of the present disclosure devised to solve the problems are not limited to the aforementioned objects, and other unmentioned objects will be clearly understood by those skilled in the art based on the following detailed description of the present disclosure.

### Technical Solution

In accordance with an aspect of the present disclosure, the above and other objects can be accomplished by the provision of an autonomous vehicle system including a communicator for generating a first signal based on service data received from a server, a plurality of sensors for generating a second signal based on generated sense data, a positioning device for generating a third signal based on generated position data of a vehicle, an autonomous driving device for recognizing a driving situation based on at least one of the first signal, the second signal or the third signal, creating an autonomous driving path based on the driving situation, and generating a fourth signal about a control parameter for driving based on the autonomous driving path, and a control device for controlling at least one vehicle driving device in response to the first signal when the fourth signal is not received.

In accordance with an embodiment of the present disclosure, the communicator receives data about a driving situation from the server when any one of the plurality of sensors fails, and generates a first-a signal based on the driving situation data, and the autonomous driving device creates the autonomous driving path based on the first-a signal.

In accordance with an embodiment of the present disclosure, the communicator transmits the position data to the server when any one of the plurality of sensors fails, and receives data about a driving situation based on the position data from the server.

In accordance with an embodiment of the present disclosure, the autonomous driving device receives the first-a signal, recognizes a driving situation based on the second signal received from sensors other than a failed one, among the plurality of sensors, compares the driving situation based on the first-a signal and the driving situation based on the second signal with each other, and creates the autonomous driving path based on a result of the comparison.

In accordance with an embodiment of the present disclosure, the autonomous driving device creates an autonomous driving path for parking in a first area based on the comparison result.

In accordance with an embodiment of the present disclosure, the communicator receives data about a control parameter for driving of the vehicle from the server when the autonomous driving device fails, and generates a first-b signal based on the control parameter data, and the control device controls the at least one vehicle driving device in response to the first-b signal.

In accordance with an embodiment of the present disclosure, the communicator transmits the position data to the server when the autonomous driving device fails, and receives, from the server, data about an autonomous driving path based on the position data and data about the control parameter for the driving based on the autonomous driving path.

In accordance with an embodiment of the present disclosure, the communicator determines that the autonomous driving device has failed, upon receiving no signal from the autonomous driving device, and transmits failure information of the autonomous driving device to the server.

In accordance with an embodiment of the present disclosure, the control device controls the at least one vehicle driving device in response to the first-b signal such that the vehicle is parked in a first area.

In accordance with an embodiment of the present disclosure, the autonomous driving device, when the positioning device fails, matches the sense data to high-definition (HD) map data to create a local map, and creates an autonomous driving path for parking in a first area based on the local map.

In accordance with an embodiment of the present disclosure, the autonomous driving device matches the sense data to the HD map data based on position data generated just before the positioning device fails, and the communicator transmits, to the server, the position data generated just before the positioning device fails.

In accordance with an embodiment of the present disclosure, the communicator includes a first communication module and a second communication module, wherein the second communication module receives the service data together with the first communication module, or receives the service data when the first communication module fails.

In accordance with an embodiment of the present disclosure, the control device includes a first control electronic control unit (ECU) and a second control ECU, wherein the second control ECU controls the at least one vehicle driving device in response to the fourth signal or the first signal when the first control ECU fails.

In accordance with another aspect of the present disclosure, there is provided an autonomous driving method of a vehicle including generating, by a communicator, a first signal based on service data received from a server, generating, by a plurality of sensors, a second signal based on generated sense data, generating, by a positioning device, a third signal based on generated position data of the vehicle, recognizing, by an autonomous driving device, a driving situation based on at least one of the first signal, the second signal or the third signal, creating, by the autonomous driving device, an autonomous driving path based on the driving situation, generating, by the autonomous driving device, a fourth signal about a control parameter for driving based on the autonomous driving path, and controlling, by a control device, at least one vehicle driving device in response to the first signal when the fourth signal is not received.

In accordance with an embodiment of the present disclosure, the generation of the first signal includes receiving, by the communicator, data about a driving situation from the server when any one of the plurality of sensors fails, and generating, by the communicator, a first-a signal based on the driving situation data, and the creation of the autonomous driving path includes creating, by the autonomous driving device, the autonomous driving path based on the first-a signal.

In accordance with an embodiment of the present disclosure, the generation of the first signal includes receiving, by the communicator, data about a control parameter for driving of the vehicle from the server when the autonomous driving device fails, and generating, by the communicator, a first-b signal based on the control parameter data, and the control of the at least one vehicle driving device includes controlling, by the control device, the at least one vehicle driving device in response to the first-b signal.

In accordance with an embodiment of the present disclosure, the autonomous driving method further includes matching, by the autonomous driving device, the sense data to high-definition (HD) map data to create a local map, when the positioning device fails, and creating, by the autonomous driving device, an autonomous driving path for parking in a first area based on the local map.

It is to be understood that details of other embodiments are included in the detailed description and the accompanying drawings.

### Advantageous Effects

The present disclosure provides one or more of the following effects.

Firstly, even in the case where any one of electronic devices of an autonomous vehicle fails, the vehicle may be induced to travel safely, thereby suppressing occurrence of an accident.

Secondly, an autonomous vehicle may receive service data appropriate to a failed electronic device, so as to properly cope with a failure situation.

It will be appreciated by those skilled in the art that the effects of the present disclosure are not limited to those that have been particularly described hereinabove and that other unmentioned effects of the present disclosure will be more clearly understood from the accompanying claims.

### DESCRIPTION OF DRAWINGS

FIG. 1 is a view showing the exterior appearance of a vehicle according to an embodiment of the present disclosure.

FIG. 2 is a control block diagram of the vehicle according to an embodiment of the present disclosure.

FIG. 3A is a view referred to for description of the overall system according to an embodiment of the present disclosure.

FIG. 3B is a signal flow chart of the overall system according to an embodiment of the present disclosure.

FIGS. 4 to 7 are views referred to for description of operations of an autonomous vehicle system in various situations according to an embodiment of the present disclosure.

FIGS. 8 to 11 are views referred to for description of an operation of a server and an operation of the vehicle according to an embodiment of the present disclosure.

### BEST MODE

Reference will now be made in detail to the exemplary embodiments of the present disclosure, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or combinations thereof.

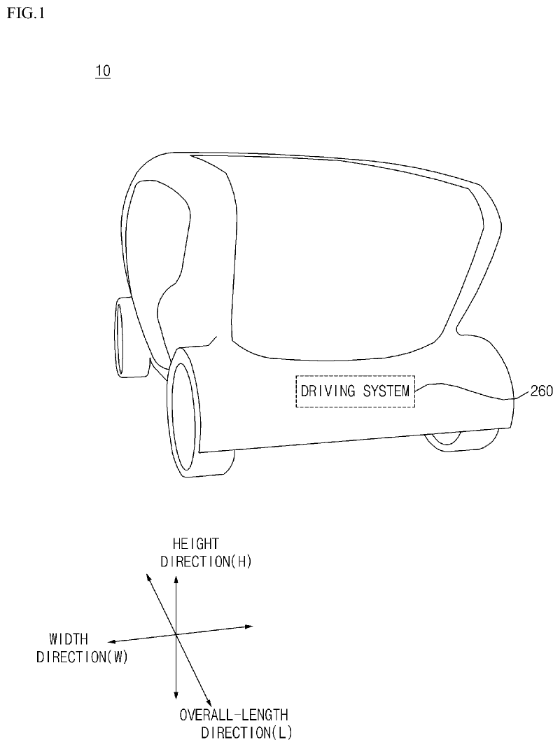

FIG. 1 is a view showing a vehicle according to an embodiment of the present disclosure.

Referring to FIG. 1, the vehicle 10 according to the embodiment of the present disclosure is defined as transportation means which runs on a road or railroad line. The vehicle 10 is a concept including an automobile, a train, and a motorcycle. The vehicle 10 may be a concept including all of an internal combustion engine vehicle having an engine as a power source, a hybrid vehicle having an engine and an electric motor as power sources, an electric vehicle having an electric motor as a power source, etc. The vehicle 10 may be a shared vehicle. The vehicle 10 may be an autonomous vehicle.

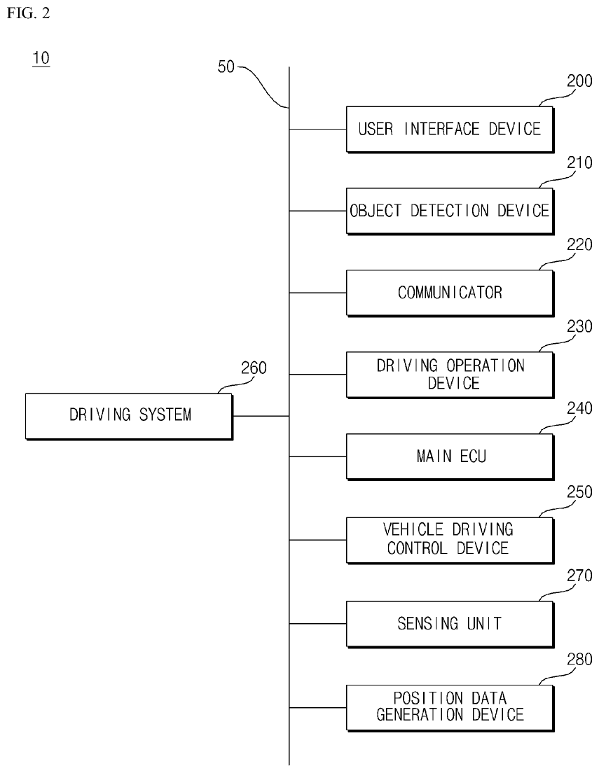

FIG. 2 is a control block diagram of the vehicle according to an embodiment of the present disclosure.

Referring to FIG. 2, the vehicle 10 may include a user interface device 200, an object detection device 210, a communicator 220, a driving operation device 230, a main electronic control unit (ECU) 240, a vehicle driving control device 250, a driving system 260, a sensing unit 270, and a position data generation device 280.

The user interface device 200 is a device for communication between the vehicle 10 and a user. The user interface device 200 may receive a user input, and provide information generated in the vehicle 10 to the user. The vehicle 10 may realize a user interface (UI) or user experience (UX) through the user interface device 200.

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasonic sensor or an infrared sensor. The object detection device 210 may provide data about an object generated based on a sense signal generated in the sensor to at least one electronic device included in the vehicle.

A plurality of sensors included in the object detection device 210 may generate a second signal based on generated sense data.

The communicator 220 may exchange a signal with a device located outside the vehicle 10. The communicator 220 may exchange a signal with at least one of infrastructure (for example, a server or a broadcasting station) or another vehicle. In order to perform communication, the communicator 220 may include at least one of a transmission antenna, a reception antenna, a radio frequency (RF) circuit or an RF element capable of implementing various communication protocols.

The communicator 220 may receive service data from the server. The communicator 220 may generate a first signal based on the service data received from the server. The first signal may include a first-a signal generated based on data about a driving situation, and a first-b signal generated based on data about a control parameter.

When any one of the plurality of sensors fails, the communicator 220 may receive data about a driving situation from the server. In the case where any one of the plurality of sensors fails, the communicator 220 may transmit failure information to the server. The communicator 220 may generate the first-a signal based on the driving situation data. The first-a signal may be understood as a signal generated for transmission of the driving situation data.

When any one of the plurality of sensors fails, the communicator 220 may transmit position data of the vehicle 10 to the server. The communicator 220 may receive data about a driving situation based on the position data from the server. The server may acquire data from another vehicle around the vehicle 10 and equipment (for example, ground equipment such as a camera, a radar and a lidar) installed around the vehicle 10. The server may generate data about a driving situation of the vehicle 10 based on received data. The communicator 220 may receive the data about the driving situation of the vehicle 10 from the server.

When the autonomous driving device 260 fails, the communicator 220 may receive data about a control parameter for driving of the vehicle 10 from the server. The communicator 220 may generate the first-b signal based on the control parameter data.

When the autonomous driving device 260 fails, the communicator 220 may transmit position data to the server. The communicator 220 may receive data about an autonomous driving path based on the position data, and data about a control parameter for driving based on the autonomous driving path. The server may acquire data from another vehicle around the vehicle 10 and equipment (for example, ground equipment such as a camera, a radar and a lidar) installed around the vehicle 10. The server may generate data about a driving situation of the vehicle 10 based on received data. Based on the driving situation data, the server may generate data about an autonomous driving path, and data about a control parameter for driving based on the autonomous driving path. The communicator 220 may receive, from the server, the data about the autonomous driving path, and the data about the control parameter for the driving based on the autonomous driving path.

Upon receiving no signal from the autonomous driving device 260, the communicator 220 may determine that the autonomous driving device 260 has failed. The communicator 220 may transmit failure information of the autonomous driving device 260 to the server.

The communicator 220 may transmit, to the server, position data generated just before the positioning device fails.

The communicator 220 may include a first communication module and a second communication module. The second communication module may receive service data together with the first communication module. The second communication module may receive service data when the first communication module fails.

The driving operation device 230 is a device which receives a user input for driving. In a manual mode, the vehicle 10 may be driven based on a signal provided by the driving operation device 230. The driving operation device 230 may include a steering input device (for example, a steering wheel), an acceleration input device (for example, an accelerator pedal), and a brake input device (for example, a brake pedal).

The main ECU 240 may control the overall operation of at least one electronic device included in the vehicle 10.

The driving control device 250 is a device which electrically controls a variety of vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

On the other hand, the safety device driving control device may include a safety belt driving control device for safety belt control.

The vehicle driving control device 250 may be referred to as a control device (for example, a control electronic control unit (ECU)).

The control device 250 may control a vehicle driving device based on a signal received from the autonomous driving device 260. For example, the control device 250 may control a powertrain or a steering device based on a signal received from the autonomous driving device 260. Upon receiving no fourth signal from the autonomous driving device 260, the control device 250 may control at least one vehicle driving device in response to the first signal received from the communicator 220.

The control device 250 may control at least one vehicle driving device in response to the first-b signal. The control device 250 may control at least one vehicle driving device in response to the first-b signal such that the vehicle 10 is parked in a first area. The first area may be defined as an area of a driving road where the probability of accident is lower. For example, the first area may be a road shoulder or an emergency evacuation zone.

Meanwhile, the control device 250 may include a first control electronic control unit (ECU) and a second control ECU. The second control ECU may control at least one vehicle driving device in response to the fourth signal or the first signal when the first control ECU fails.

The driving system 260 may generate a signal for control of motion of the vehicle 10 or output of information to the user based on data about an object received from the object detection device 210. The driving system 260 may provide the generated signal to at least one of the user interface device 200, the main ECU 240 or the vehicle driving control device 250.

The driving system 260 may be a concept including an advanced driver assistance system (ADAS). The ADAS 260 may embody at least one of an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The driving system 260 may include an autonomous driving device (for example, an autonomous driving electronic control unit (ECU)). The autonomous driving device may set an autonomous driving path based on data received from at least one of other electronic devices in the vehicle 10. The autonomous driving device may set an autonomous driving path based on data received from at least one of the user interface device 200, the object detection device 210, the communicator 220, the sensing unit 270, or the position data generation device 280. The autonomous driving device may generate a control signal such that the vehicle 10 travels along the autonomous driving path. The control signal generated from the autonomous driving device may be provided to at least one of the main ECU 240 or the vehicle driving control device 250.

The autonomous driving device 260 may recognize a driving situation based on at least one of the first signal generated by the communicator 220, the second signal generated by the plurality of sensors 210, or a third signal generated by the positioning device 280. The autonomous driving device 260 may create an autonomous driving path based on the driving situation. The autonomous driving device 260 may generate the fourth signal about a control parameter for driving based on the autonomous driving path. The autonomous driving device 260 may provide the fourth signal to the control device 250. The control device 250 may control driving of the vehicle 10 in response to the fourth signal. The vehicle 10 may travel along the autonomous driving path created by the autonomous driving device 260.

The autonomous driving device 260 may create an autonomous driving path based on the first-a signal received from the communicator 220. When any one of the plurality of sensors fails, the autonomous driving device 260 may create an autonomous driving path based on data about a driving situation, generated by the server and received through the communicator 220.

The autonomous driving device 260 may receive the first-a signal from the communicator 220. The autonomous driving device 260 may recognize a driving situation based on the second signal received from sensors other than a failed one, among the plurality of sensors. The autonomous driving device 260 may compare the driving situation based on the first-a signal and the driving situation based on the second signal with each other. The autonomous driving device 260 may create an autonomous driving path based on a result of the comparison.

Based on the comparison result, the autonomous driving device 260 may create an autonomous driving path for allowing the vehicle 10 to be parked in the first area. The first area may be defined as an area of a driving road where the probability of accident is lower.

When the positioning device 280 fails, the autonomous driving device 260 may match sense data to high-definition (HD) map data to create a local map. The HD map data may be received from an HD map server through the communicator 220. The autonomous driving device 260 may receive, from the HD map server, HD map data based on position data generated just before the positioning device 280 fails. The sense data may be generated from the plurality of sensors of the object detection device 210. The autonomous driving device 260 may create an autonomous driving path for parking in the first area based on the local map. The first area may be defined as an area of a driving road where the probability of accident is lower. The autonomous driving device 260 may match the sense data to the HD map data based on the position data generated just before the positioning device 280 fails.

The sensing unit 270 may sense the status of the vehicle. The sensing unit 270 may include at least one of an inertial measurement unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a steering wheel rotation-based steering sensor, an in-vehicle temperature sensor, an in-vehicle humidity sensor, an ultrasonic sensor, an illumination sensor, an accelerator pedal position sensor, or a brake pedal position sensor. On the other hand, the inertial measurement unit (IMU) sensor may include at least one of an acceleration sensor, a gyro sensor, or a magnetic sensor.

The sensing unit 270 may generate vehicle status data based on a signal generated from at least one sensor. The sensing unit 270 may acquire sense signals about vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, in-vehicle temperature information, in-vehicle humidity information, a steering wheel rotation angle, an illumination outside the vehicle, a pressure applied to an accelerator pedal, a pressure applied to a brake pedal, etc.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), etc.

The sensing unit 270 may generate vehicle status information based on sense data. The vehicle status information may be information generated based on data sensed by a variety of sensors included in the vehicle.

For example, the vehicle status information may include vehicle posture information, vehicle speed information, vehicle inclination information, vehicle weight information, vehicle direction information, vehicle battery information, vehicle fuel information, vehicle tire air pressure information, vehicle steering information, in-vehicle temperature information, in-vehicle humidity information, pedal position information, and vehicle engine temperature information.

Meanwhile, the sensing unit may include a tension sensor. The tension sensor may generate a sense signal based on a tension state of a safety belt.

The position data generation device 280 may generate position data of the vehicle 10. The position data generation device 280 may include at least one of a global positioning system (GPS) or a differential global positioning system (DGPS). The position data generation device 280 may generate position data of the vehicle 10 based on a signal generated from at least one of the GPS or the DGPS. In some embodiments, the position data generation device 280 may correct position data based on at least one of an inertial measurement unit (IMU) of the sensing unit 270 or a camera of the object detection device 210.

The position data generation device 280 may be referred to as a positioning device. The positioning device 280 may generate the third signal based on the generated position data of the vehicle 10. The position data generation device 280 may be referred to as a global navigation satellite system (GNSS).

The vehicle 10 may include an inner communication system 50. A plurality of electronic devices included in the vehicle 10 may exchange signals via the inner communication system 50. Data may be included in the signals. The inner communication system 50 may utilize at least one communication protocol (for example, CAN, LIN, FlexRay, MOST, or Ethernet).

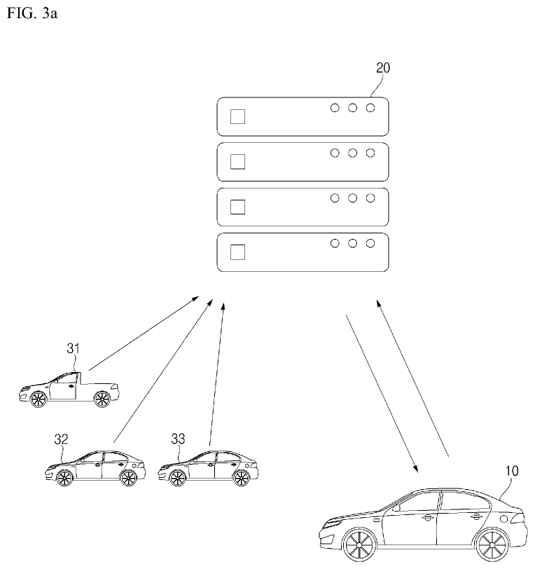

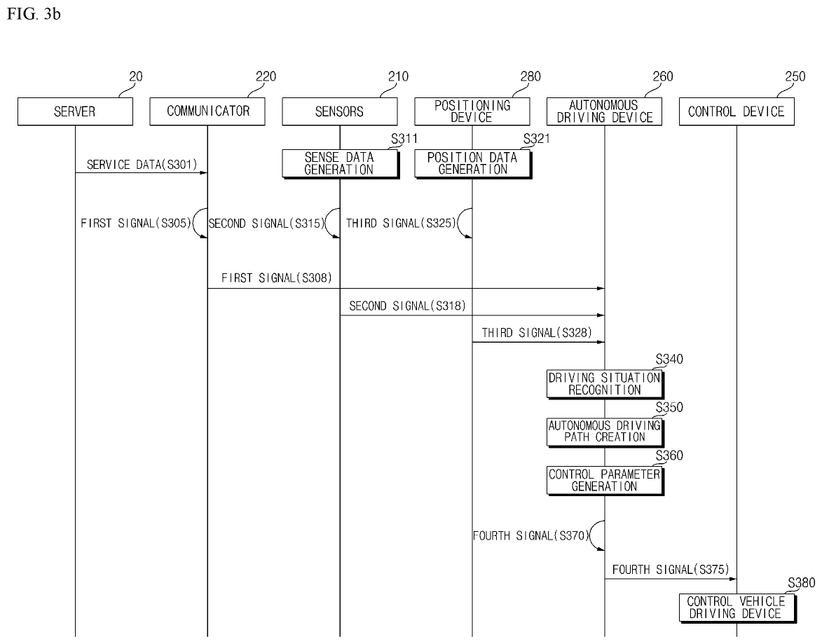

FIG. 3A is a view referred to for description of the overall system according to an embodiment of the present disclosure.

Referring to FIG. 3A, the system may include the vehicle 10 and the server 20. Electronic devices included in the autonomous vehicle 10 may fail due to various causes. When even one of the electronic devices included in the autonomous vehicle 10 fails, autonomous driving may not be smoothly performed, thereby causing an accident. In order to solve this problem, there is a need to, for the autonomous driving, utilize recognition, determination and control algorithms of the high-performance server 20 over a communication network (for example, a 5G communication network), as well as utilizing a self-algorithm of the vehicle 10. A more secure system may be embodied by providing an autonomous driving service over the communication network.

The vehicle 10 and the server 20 may exchange signals, information or data over the communication network. The vehicle 10 may autonomously travel based on the self-algorithm. When an electronic device included in the vehicle 10 fails, the vehicle 10 may autonomously travel based on recognition, determination and control result values generated by the server 20.

The server 20 may recognize a driving situation of the vehicle 10 based on data received from the vehicle 10 or other vehicles 31, 32 and 33. The server 20 may create an autonomous driving path of the vehicle 10 based on the recognized driving situation. The server 20 may generate a control parameter such that the vehicle 10 travels along the autonomous driving path.

FIG. 3B is a signal flow chart of the overall system according to an embodiment of the present disclosure. FIG. 3B is a signal flow chart referred to for description of an autonomous driving method of the vehicle.

Referring to FIG. 3B, the communicator 220 may receive service data from the server 20 (S301). The service data may be data generated by the server 20. The service data may be data generated based on a driving situation recognized by the server 20. The service data may be data generated based on an autonomous driving path created by the server 20. The service data may be data generated based on a control parameter generated by the server 20. The communicator 220 may generate a first signal based on the service data (S305). Step S305 of generating the first signal may include the step of receiving data about a driving situation from the server 20 by the communicator 220 when any one of the plurality of sensors 210 fails, and the step of generating a first-a signal based on the driving situation data by the communicator 220. Step S305 of generating the first signal may include the step of receiving data about a control parameter for driving of the vehicle 10 from the server 20 by the communicator 220 when the autonomous driving device 260 fails, and the step of generating a first-b signal based on the control parameter data by the communicator 220.

The communicator 220 may transmit the first signal to the autonomous driving device 260.

The plurality of sensors 210 may generate sense data (S311). The plurality of sensors 210 may generate a second signal based on the sense data (S315). The plurality of sensors 210 may transmit the second signal to the autonomous driving device 260.

The positioning device 280 may generate position data of the vehicle 10 (S321). The positioning device 280 may generate a third signal based on the generated position data of the vehicle 10 (S325). The positioning device 280 may transmit the third signal to the autonomous driving device 260.

The autonomous driving device 260 may receive the first signal from the communicator 220. The autonomous driving device 260 may receive the second signal from the plurality of sensors 210. The autonomous driving device 260 may receive the third signal from the positioning device 280. The autonomous driving device 260 may recognize a driving situation based on at least one of the first signal, the second signal or the third signal (S340). The autonomous driving device 260 may create an autonomous driving path based on the driving situation (S350). Step S350 of creating the autonomous driving path may include the step of creating the autonomous driving path based on the first-a signal by the autonomous driving device 260.

The autonomous driving device 260 may generate a fourth signal about a control parameter for driving of the vehicle 10 based on the autonomous driving path (S360).

The control device 250 may receive the fourth signal (S375). The control device 250 may control at least one vehicle driving device in response to the fourth signal (S380). When the fourth signal is not received, the control device 250 may control at least one vehicle driving device in response to the first signal received from the communicator 220. Step S380 of controlling the at least one vehicle driving device may include the step of controlling the at least one vehicle driving device in response to the first-b signal by the control device 250.

Meanwhile, the autonomous driving method of the vehicle may further include the step of matching, by the autonomous driving device 260, sense data to HD map data to create a local map, when the positioning device 280 fails, and the step of creating, by the autonomous driving device 260, an autonomous driving path for parking in a first area based on the local map.

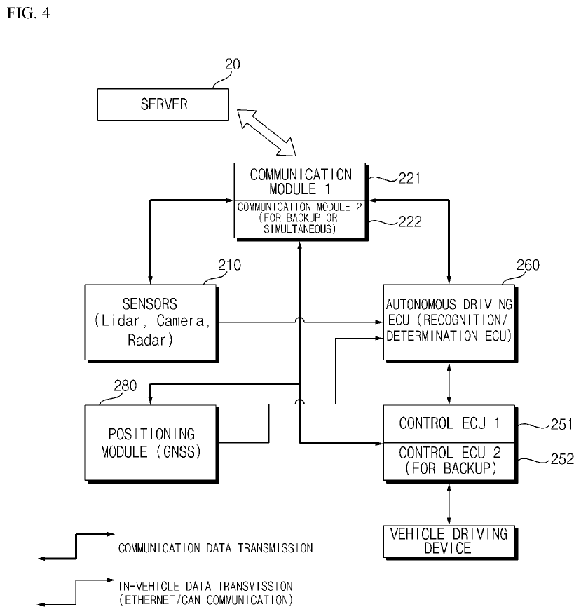

FIGS. 4 to 7 are views referred to for description of operations of an autonomous vehicle system in various situations according to an embodiment of the present disclosure.

Referring to FIG. 4, the communicator 220 may include a first communication module 221 and a second communication module 222. The second communication module 222 may be utilized for backup. The second communication module 222 may receive signals, data and information from the server 20 when the first communication module 221 fails. In some embodiments, in order to enhance performance of the system, the first communication module 221 and the second communication module 222 may simultaneously receive signals, data and information from the server 20.

The control device 250 may include a first control ECU 251 and a second control ECU 252. The first control ECU 251 may always be utilized for autonomous driving only. In some embodiments, the second control ECU 252 may be a sub-element of the user interface device 200 at normal times, which may perform a control operation for interaction between the vehicle 10 and the user. For example, the second control ECU 252 may be a sub-element of an audio/video (A/V) system or a telematics system. The second control ECU 252 may instead perform an operation performed by the first control ECU 251 when the first control ECU 251 fails.

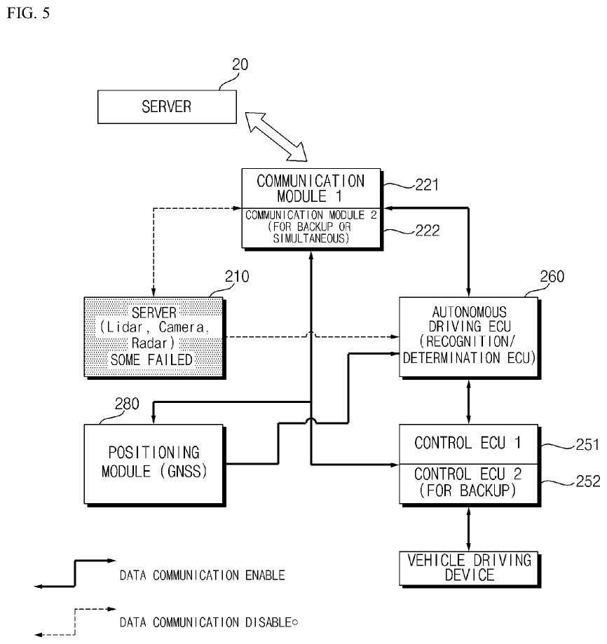

Referring to FIG. 5, some of the plurality of sensors in the object detection device 210 may fail. A determination as to whether the sensors have failed may be made by the communicator 220 or the autonomous driving device 260. The communicator 220 or autonomous driving device 260 may determine whether the sensors have failed, based on whether signals have been normally exchanged.

The autonomous driving device 260 may receive a sense data-based second signal from sensors (normal sensors) other than failed ones, among the plurality of sensors. The autonomous driving device 260 may recognize a driving situation based on the second signal received from the normal sensors.

On the other hand, when some of the plurality of sensors in the object detection device 210 fail, the communicator 220 may transmit failure information to the server 20. The communicator 220 may receive service data based on a driving situation from the server 20. The communicator 220 may generate a first-a signal based on the service data, and the autonomous driving device 260 may receive the first-a signal. The autonomous driving device 260 may compare driving situation information based on the first-a signal and driving situation information based on the second signal with each other and create an autonomous driving path based on a result of the comparison.

For example, the autonomous driving device 260 may select any one of a result value based on the first-a signal and a result value based on the second signal and create an autonomous driving path based on the selected result value. For example, the autonomous driving device 260 may create an autonomous driving path only when the result value based on the first-a signal and the result value based on the second signal are the same.

The autonomous driving device 260 may create an autonomous driving path for parking in a safe area based on at least one of the driving situation information based on the first-a signal or the driving situation information based on the second signal.

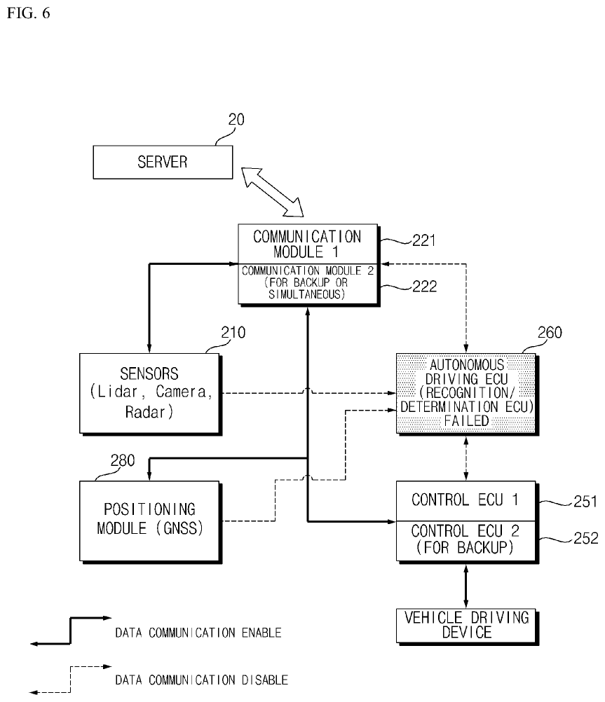

Referring to FIG. 6, the autonomous driving device 260 may fail. A determination as to whether the autonomous driving device 260 has failed may be made by the communicator 220. The communicator 220 may determine whether the autonomous driving device 260 has failed, based on whether signals have been normally exchanged.

When the autonomous driving device 260 fails, the communicator 220 may transmit failure information to the server 20. The communicator 220 may receive service data based on an autonomous driving path and a control parameter from the server 20. The communicator 220 may provide the received service data to the control device 250. The control device 250 may control at least one vehicle driving device based on the received service data.

Meanwhile, the service data generated by the server 20 may be data based on an autonomous driving path for allowing the vehicle 10 to be parked in a safe area, and a control parameter. The control device 250 may perform a control operation based on the service data such that the vehicle 10 is parked in the safe area.

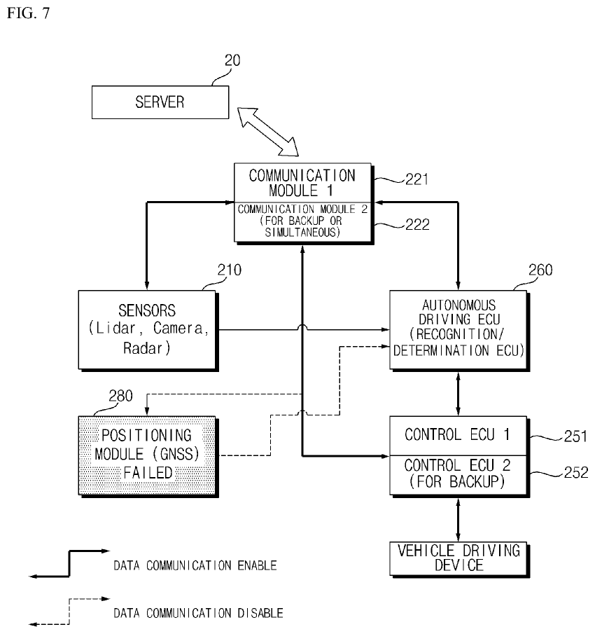

Referring to FIG. 7, the positioning device 280 may fail. A determination as to whether the positioning device 280 has failed may be made by the communicator 220 or the autonomous driving device 260. The communicator 220 or autonomous driving device 260 may determine whether the positioning device 280 has failed, based on whether signals have been normally exchanged.

The autonomous driving device 260 may create a local map using only the sensors of the object detection device 210 in a map-matching scheme based on last positioning data and HD map data. The autonomous driving device 260 may perform a control operation based on the local map such that the vehicle 10 is parked in a safe area.

When the positioning device 280 fails, the communicator 220 may transmit failure information to the server 20. The server 20 may search for another vehicle around the vehicle 10 based on last positioning data of the vehicle 10. The server 20 may receive sense data from the other vehicle around the vehicle 10 and generate driving situation information of the vehicle 10 based on the received sense data. The server 20 may calculate the position of the vehicle 10 based on the sense data received from the other vehicle around the vehicle 10. The communicator 220 may receive position data of the vehicle 10 from the server 20.

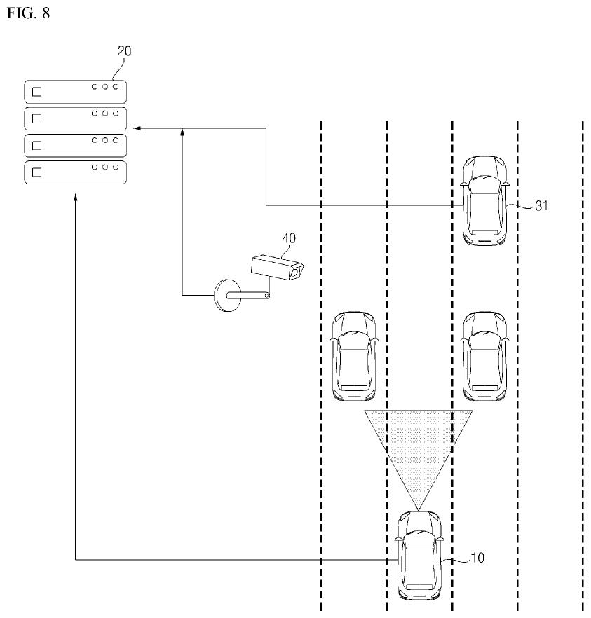

FIGS. 8 to 11 are views referred to for description of an operation of the server and an operation of the vehicle according to an embodiment of the present disclosure.

Referring to FIG. 8, when a sensor of the vehicle 10 fails, or malfunctions due to a weather condition, a road environment, or the like, the probability of accident increases. Even in the case where all sensors of the vehicle 10 fail to be used, it is necessary to stop the vehicle 10 at a safe position. In this case, the vehicle 10 may receive service data from the server 20 and be parked in a safe area based on the service data.

The server 20 may receive and use sense data from another vehicle 31 around the vehicle 10. The other vehicle 31 may use the same service as that of the vehicle 10. The server 20 may receive sense data generated by equipment installed on a road, such as a camera 40, a radar and a lidar. For example, the camera 40, the radar and the lidar may be installed in a location where a road environment is poor or fog occurs frequently. The server 20 may receive and use sense data from the camera 40, the radar and the lidar installed on the road. The server 20 may receive and use sense data generated by the vehicle 10.

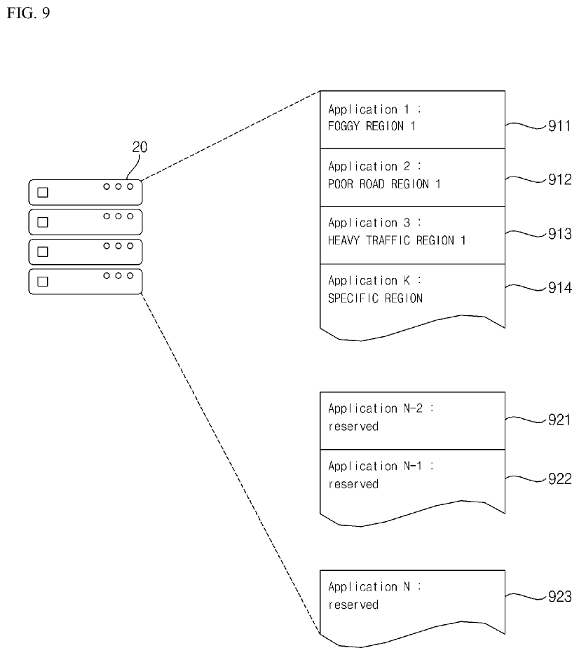

Referring to FIG. 9, the server 20 may drive a plurality of applications in a multiple manner. The server 20 may generate service data 911, 912, 913 and 914 by regions. For example, the server 20 may receive sense data from vehicles or infrastructure located in a foggy region, a poor road region, a heavy traffic region, etc. The server 20 may generate the service data based on the received sense data.

The server 20 may generate service data 921, 922 and 923 by vehicles. The server 20 may generate service data associated with at least one of recognition, determination or control on a vehicle basis and provide the generated service data to each vehicle. The server 20 may generate service data matched to a registered level. For example, the server 20 may generate and provide service data associated with recognition to a vehicle registered as a low level. For example, the server 20 may generate and provide service data associated with recognition, determination and control to a vehicle registered as a high level.

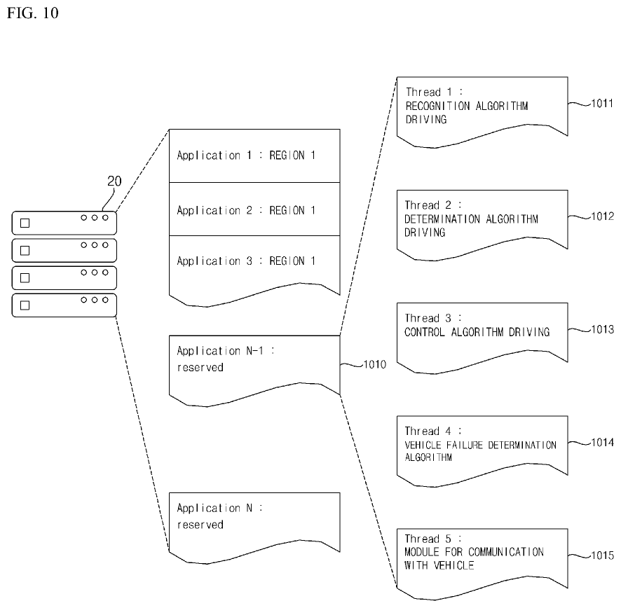

Referring to FIG. 10, the server 20 may drive applications for generating service data by vehicles. The server 20 may recognize (1011) a driving situation of the vehicle 10 based on received sense data and generate service data based on the driving situation. The server 20 may create an autonomous driving path (1012) based on driving situation information generated thereby and position data of the vehicle received from the vehicle 10 and generate service data based on the autonomous driving path. The server 20 may generate a control parameter (1013) based on the autonomous driving path created thereby and control data of the vehicle 10 received from the vehicle 10 and generate service data based on the control parameter.

The server 20 may receive recognition, determination and control data of the vehicle 10 from the vehicle 10. The server 20 may compare (1014) recognition, determination and control data generated thereby with the recognition, determination and control data of the vehicle 10. The server 20 may determine whether the vehicle 10 has failed, based on a result of the comparison.

The server 20 may receive signals, data and information from the vehicle 10. The server 20 may receive information about the type of the vehicle and mileage information from the vehicle 10. The server 20 may receive raw data of sense data from the vehicle 10. The server 20 may receive object detection data (recognition data) processed by the vehicle 10 from the vehicle 10. The server 20 may receive autonomous driving path data (determination data) processed by the vehicle 10 from the vehicle 10. The server 20 may receive a control parameter (control data) processed by the vehicle 10 from the vehicle 10.

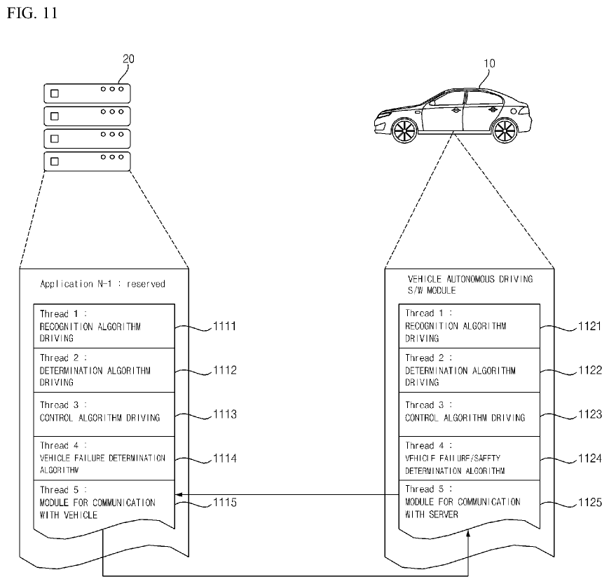

Referring to FIG. 11, the server 20 may drive a recognition algorithm (1111), a determination algorithm (1112), a control algorithm (1113), a vehicle 10 failure determination algorithm (1114), and a communication algorithm (1115). The vehicle 20 may drive a recognition algorithm (1121), a determination algorithm (1122), a control algorithm (1123), a vehicle 10 failure determination algorithm (1124), and a communication algorithm (1125).

Generally, a control period required at 100 km/h is on the order of 40˜50 msec. Provided that the speed of the vehicle is reduced to 50 km/h due to a problem with the vehicle, the control period will be on the order of twice, 80˜100 msec. In 5G communication, the latency is as short as 1 msec or less, and the maximum data rate is 20 Gbps. Assuming that a data transmission period for every sampling is 1Frame, the amount of data expected per 1Frame may be different depending on a sensor set. However, a camera image may be compressed such that the total data amount does not exceed 1 Gbps, thereby making it possible to control the vehicle in real time.

Assuming that the amount of transmission data including raw data of a sensor such as a camera image is 1 Gbps, the amount of data to be transmitted per control period of 100 msec is 10 Gbit and the maximum data rate of 5G communication is 20 Gbps, so 20 Gbit per 100 msec may be transmitted (20 Gbps=20 Gbit/1000 msec=2 Gbit/100 msec). As a result, all data may be transmitted within the minimum control period of 50 msec. Because received data processed and transmitted by the server are result parameters of recognition, determination and control algorithms, the amount thereof is 1 Mbps or less.

Provided that the control period of the vehicle is short, the server should drive a program within a short time, too, thereby causing a large amount of calculation load to be applied to the server. Further, data to be transmitted through communication should be transmitted fast, too. In the case where there is no special abnormality in the vehicle, the current speed of the vehicle is maintained using only fused sensor results of the vehicle. In the case where an error, such as sensor failure, occurs in the vehicle, raw data of sensors of the vehicle may be received and processed by lowering the speed of the vehicle and lengthening the control period. For example, the vehicle may enter an emergency driving mode by lowering the speed of the vehicle to 50 km/h and lengthening the control period to 80˜100 msec, and the server may directly receive raw data of sensors, calculate an algorithm and detect an obstacle.

The amount of data of the vehicle transmittable per 100 msec through 5G communication is 2 Gbps. Assuming that the total raw data amount is 1 Gbps, data transmission may be made within 50 msec. The amount of data of results transmitted from the server is 1 Mbps or less. Therefore, the server may control the vehicle 10 at the control period of 60 msec.

The present disclosure as described above may be implemented as computer-readable code on a program storage medium. The computer-readable medium may be any type of recording device in which data is stored in a computer-readable manner. The computer-readable medium may include, for example, a hard disk drive (HDD), a solid-state disk (SSD), a silicon disk drive (SDD), a read-only memory (ROM), a random access memory (RAM), a compact disc read-only memory (CD-ROM), a magnetic tape, a floppy disk, and an optical data storage device, as well as implementation as carrier waves (e.g., transmission over the Internet). In addition, the computer may include a processor or a controller. Accordingly, the above detailed description is not to be construed as limiting the present disclosure in any aspect, but is to be considered by way of example. The scope of the present disclosure should be determined by reasonable interpretation of the accompanying claims, and all equivalent modifications made without departing from the scope of the present disclosure should be understood as being included in the following claims.

1. An autonomous vehicle system comprising:
a communicator configured to generate a first signal based on service data received from a server;
a plurality of sensors configured to generate a second signal based on generated sense data;
a positioning device configured to generate a third signal based on generated position data of a vehicle;
an autonomous driving device configured to recognize a driving situation based on at least one of the first signal, the second signal or the third signal, create an autonomous driving path based on the driving situation, and generate a fourth signal about a control parameter for driving based on the autonomous driving path; and
a control device configured to control at least one vehicle driving device in response to the first signal when the fourth signal is not received.

2. The autonomous vehicle system according to claim 1, wherein:
the communicator is configured to receive data about a driving situation from the server when any one of the plurality of sensors fails, and generate a first-a signal based on the driving situation data; and
the autonomous driving device is configured to create the autonomous driving path based on the first-a signal.

3. The autonomous vehicle system according to claim 2, wherein the communicator is configured to transmit the position data to the server when any one of the plurality of sensors fails, and receive data about a driving situation based on the position data from the server.

4. The autonomous vehicle system according to claim 2, wherein the autonomous driving device is configured to receive the first-a signal, recognize a driving situation based on the second signal received from sensors other than a failed one, among the plurality of sensors, compare the driving situation based on the first-a signal and the driving situation based on the second signal with each other, and create the autonomous driving path based on a result of the comparison.

5. The autonomous vehicle system according to claim 4, wherein the autonomous driving device is configured to create an autonomous driving path for parking in a first area based on the comparison result.

6. The autonomous vehicle system according to claim 1, wherein:
the communicator is configured to receive data about a control parameter for driving of the vehicle from the server when the autonomous driving device fails, and generate a first-b signal based on the control parameter data; and
the control device is configured to control the at least one vehicle driving device in response to the first-b signal.

7. The autonomous vehicle system according to claim 6, wherein the communicator is configured to transmit the position data to the server when the autonomous driving device fails, and receive, from the server, data about an autonomous driving path based on the position data and data about the control parameter for the driving based on the autonomous driving path.

8. The autonomous vehicle system according to claim 6, wherein the communicator is configured to determine that the autonomous driving device has failed, upon receiving no signal from the autonomous driving device, and transmit failure information of the autonomous driving device to the server.

9. The autonomous vehicle system according to claim 6, wherein the control device is configured to control the at least one vehicle driving device in response to the first-b signal such that the vehicle is parked in a first area.

10. The autonomous vehicle system according to claim 1, wherein the autonomous driving device is configured to, when the positioning device fails, match the sense data to high-definition (HD) map data to create a local map, and create an autonomous driving path for parking in a first area based on the local map.

11. The autonomous vehicle system according to claim 10, wherein:
the autonomous driving device is configured to match the sense data to the HD map data based on position data generated just before the positioning device fails; and
the communicator is configured to transmit, to the server, the position data generated just before the positioning device fails.

12. The autonomous vehicle system according to claim 1, wherein the communicator comprises a first communication module and a second communication module,
wherein the second communication module is configured to receive the service data together with the first communication module, or receive the service data when the first communication module fails.

13. The autonomous vehicle system according to claim 1, wherein the control device comprises a first control electronic control unit (ECU) and a second control ECU,
wherein the second control ECU is configured to control the at least one vehicle driving device in response to the fourth signal or the first signal when the first control ECU fails.

14. An autonomous driving method of a vehicle comprising:
generating, by a communicator, a first signal based on service data received from a server;
generating, by a plurality of sensors, a second signal based on generated sense data;
generating, by a positioning device, a third signal based on generated position data of the vehicle;
recognizing, by an autonomous driving device, a driving situation based on at least one of the first signal, the second signal or the third signal;
creating, by the autonomous driving device, an autonomous driving path based on the driving situation;
generating, by the autonomous driving device, a fourth signal about a control parameter for driving based on the autonomous driving path; and
controlling, by a control device, at least one vehicle driving device in response to the first signal when the fourth signal is not received.

15. The autonomous driving method according to claim 14, wherein the generating the first signal comprises:
receiving, by the communicator, data about a driving situation from the server when any one of the plurality of sensors fails; and
generating, by the communicator, a first-a signal based on the driving situation data; and
wherein the creating the autonomous driving path comprises creating, by the autonomous driving device, the autonomous driving path based on the first-a signal.

16. The autonomous driving method according to claim 14, wherein the generating the first signal comprises:
receiving, by the communicator, data about a control parameter for driving of the vehicle from the server when the autonomous driving device fails; and
generating, by the communicator, a first-b signal based on the control parameter data; and
wherein the controlling the at least one vehicle driving device comprises controlling, by the control device, the at least one vehicle driving device in response to the first-b signal.

17. The autonomous driving method according to claim 14, further comprising:
matching, by the autonomous driving device, the sense data to high-definition (HD) map data to create a local map, when the positioning device fails; and
creating, by the autonomous driving device, an autonomous driving path for parking in a first area based on the local map.
